(19) United States
(12) Patent Application Publication
(10) Pub. No.: US 2026/0077651 A1
(43) Pub. Date: Mar. 19, 2026

(54) DISPLAY CONTROL APPARATUS AND DISPLAY CONTROL METHOD

(71) Applicant: ISUZU MOTORS LIMITED, Yokohama-shi (JP)

(72) Inventor: Tomokazu TOJO, Fujisawa-shi (JP)

(21) Appl. No.: 19/275,130

(22) Filed: Jul. 21, 2025

(30) Foreign Application Priority Data
Sep. 18, 2024 (JP) 2024-160754

(51) Int. Cl. B60K 35/81; B60K 35/28; B60K 35/29

(52) U.S. Cl. CPC B60K 35/81; B60K 35/28; B60K 35/29; B60K 2360/167; B60K 2360/172; B60K 2360/178; B60K 2360/1868; B60K 2360/1876

(57) ABSTRACT

A display control apparatus has: an accepting section that accepts operation; a sensing section that senses an object; an acquiring section that acquires: vehicle speed information representing a vehicle speed; pedal information representing a state of a brake pedal; and transmission information representing a state of a transmission; and a display control section that causes the display section to display a first image upon sensing of the object, in which, in a case where the state of the transmission is neutral, the vehicle speed is equal to or lower than a predetermined vehicle speed, and the brake pedal is in a pressed state, the display control section changes the first image being displayed by the display section to a second image in response to acceptance of operation by the accepting section.

### CROSS-REFERENCE TO RELATED APPLICATIONS

The present application claims priority to Japanese Patent Application number 2024-160754, filed on Sep. 18, 2024, contents of which are incorporated herein by reference in its entirety.

### BACKGROUND OF THE INVENTION

The present invention relates to a display control apparatus and a display control method.

Conventional vehicle display systems permit or prohibit customized operation of a display screen mounted on a vehicle on the basis of the distance between the vehicle and an obstacle, the vehicle speed, and the shift position (e.g. Japanese Patent Application Publication No. 2022-156438).

### PROBLEMS TO BE SOLVED BY THE INVENTION

There is a vehicle display system proposed which, from the standpoint of safety, prohibits operation of a display screen by a driver in order to cause the driver to recognize that a pedestrian walking in front of the vehicle or another vehicle in front of the vehicle has been sensed as an obstacle by displaying information to that effect on the display screen. However, it is not possible with the vehicle display system described above to operate the display screen if there is an object such as a pedestrian in front of the vehicle in a case where the driver desires to operate the display screen in order to check the vehicle state or the like when the vehicle has temporarily stopped due to a signal or the vehicle has stopped temporarily due to the occurrence of a traffic jam.

### BRIEF SUMMARY OF THE INVENTION

The present invention has been made in view of these matters, and an object thereof is to permit operation of a display screen at an appropriate timing.

### MEANS FOR SOLVING THE PROBLEMS

A display control apparatus according to a first aspect of the present invention has: an accepting section that accepts operation of a display section included in a vehicle; a sensing section that senses an object in front of the vehicle; an acquiring section that acquires: vehicle speed information representing a vehicle speed of the vehicle; pedal information representing a state of a brake pedal operated by a driver of the vehicle; and transmission information representing a state of a transmission operated by the driver; and a display control section that causes the display section to display a first image upon sensing of the object by the sensing section, in which in a case where the state of the transmission is neutral, the vehicle speed is equal to or lower than a predetermined vehicle speed, and the brake pedal is in a pressed state, the display control section changes the first image being displayed by the display section to a second image corresponding to predetermined operation in response to acceptance of the predetermined operation by the accepting section.

A display control method according to a second aspect of the present invention is a display control method executed by a computer, the display control method having: an acceptance step of accepting operation of a display section included in a vehicle; a sensing step of sensing an object in front of the vehicle; an acquisition step of acquiring: vehicle speed information representing a vehicle speed of the vehicle; pedal information representing a state of a brake pedal operated by a driver of the vehicle; and transmission information representing a state of a transmission operated by the driver; and a display control step of causing the display section to display a first image upon sensing of the object at the sensing step, in which at the display control step, in a case where the state of the transmission is neutral, the vehicle speed is equal to or lower than a predetermined vehicle speed, and the state of the brake pedal is in a pressed state, the first image being displayed by the display section is changed to a second image corresponding to predetermined operation in response to acceptance of the predetermined operation at the acceptance step.

### BRIEF DESCRIPTION OF THE DRAWINGS

FIG. 1 is a drawing depicting a summary of a vehicle S according to the present embodiment.

FIG. 2 is a drawing depicting an example of a first image and second images.

FIG. 3 is a drawing depicting an example of a display table.

FIG. 4 is a drawing depicting an example of a process sequence at a display control apparatus 10.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### Summary of Vehicle S

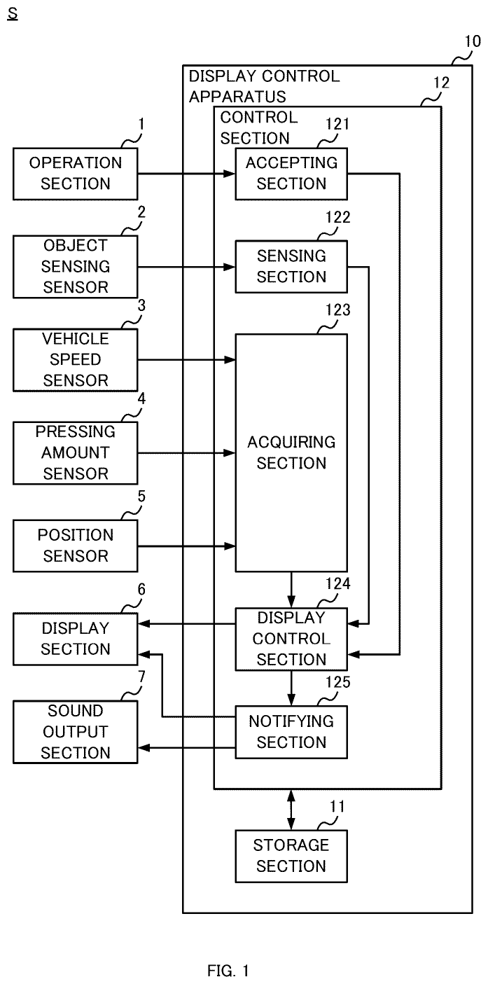

FIG. 1 is a drawing depicting a summary of a vehicle S according to the present embodiment. The vehicle S depicted in FIG. 1 includes an operation section 1, an object sensing sensor 2, a vehicle speed sensor 3, a pressing amount sensor 4, a position sensor 5, a display section 6, a sound output section 7, and a display control apparatus 10. The vehicle S has a function to cause a display included in the instrument panel to display a first image representing that an object in front of the vehicle S has been sensed, and a second image representing a vehicle state such as the traveling state of the vehicle S or the state of an auxiliary device. For example, the object is a pedestrian, a bicycle, or another vehicle in front of the vehicle S. For example, the traveling state is the traveling distance, the average fuel consumption, or the average vehicle speed, and, as an example, the state of the auxiliary device is whether DPD (Diesel Particulate Diffuser) reproduction is necessary or not necessary.

The operation section 1 is a switch or a touch panel that is provided on the instrument panel or a steering wheel for a driver to operate. For example, the driver of the vehicle S causes a display included in the instrument panel to display the first image or a second image by operating the switch provided on the instrument panel.

The object sensing sensor 2 is a sensor for sensing an object in front of the vehicle S, and, for example, includes an infrared sensor. For example, the object sensing sensor 2 senses an object included in the range within 4 m from the leading end of the vehicle S in the advancing direction of the vehicle S and within 2 m from the center of the vehicle S in the vehicle width direction of the vehicle S, and outputs a sensing signal representing that the object has been sensed. The vehicle speed sensor 3 includes a sensor for sensing the vehicle speed of the vehicle S, and outputs vehicle speed information representing the sensed vehicle speed. The pressing amount sensor 4 includes a sensor for sensing that the brake pedal of the vehicle S has been pressed, and outputs pedal information representing whether or not the brake pedal is in the pressed state.

The position sensor 5 includes a sensor for sensing the state of gears included in the transmission (not depicted) corresponding to the shift position of the shift lever operated by the driver. For example, the state of gears is the number of engaged forward gears, whether or not the reverse gear is in the engaged state, or whether or not a gear is in the fixed state. For example, the position sensor 5 includes a gear position sensor that senses the number of engaged forward gears and a back gear sensor that senses the engagement of the reverse gear, and outputs transmission information including the state of the transmission corresponding to the sensed state of gears. For example, the state of the transmission is drive “D” or the number of engaged forward gears, parking “P,” reverse “R,” or neutral “N.”

For example, in a case where it is sensed that a gear is in a fixed state, the position sensor 5 determines that the state of the transmission is parking “P.” For example, in a case where the engaged state of the reverse gear is sensed, the position sensor 5 determines that the state of the transmission is reverse “R.” For example, in a case where it is sensed that the forward gears are in the unengaged state, the reverse gear is in the unengaged state, and the gears are in the unfixed state, the position sensor 5 determines that the state of the transmission is neutral “N.” In a case where the state of the transmission is neutral “N,” the vehicle S does not move even if the driver presses the accelerator. In a case where it is sensed that the number of engaged forward gears is equal to or greater than one, the position sensor 5 determines that the state of the transmission is drive “D.” The position sensor 5 may include a shift position sensor, and output transmission information including the state of the transmission corresponding to the position of the shift lever sensed by the shift position sensor.

The display section 6 is a display included in the instrument panel of the vehicle S, and displays the first image and a second image that can be switched. For example, the display section 6 is controlled by the display control apparatus 10 to hide one image of the first image and a second image when the other image is being displayed. The sound output section 7 is speakers provided around the instrument panel of the vehicle S.

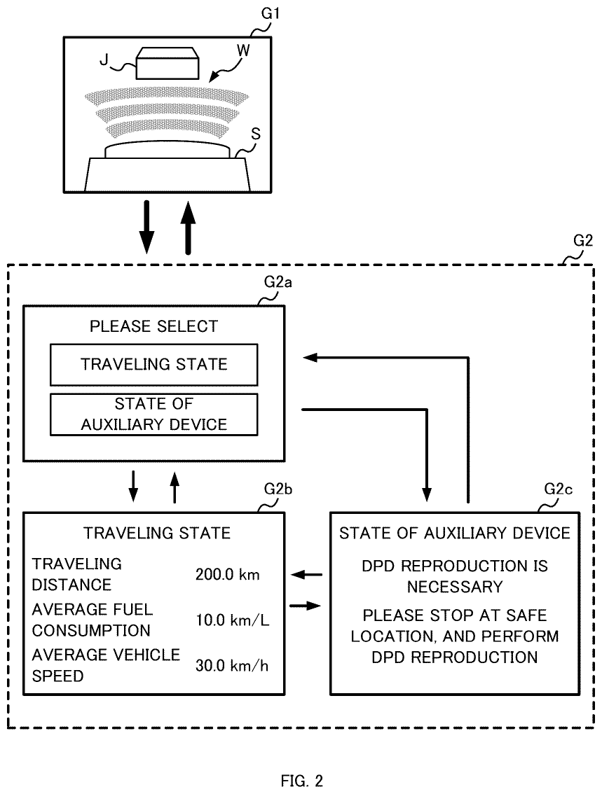

The display control apparatus 10 is an apparatus for causing the display section 6 to display the first image and second images. FIG. 2 is a drawing depicting an example of the first image and the second images. FIG. 2 depicts a first image G1 and a plurality of second images G2 (second image G2a, second image G2b, and second image G2c). The first image G1 includes an image representing the vehicle S, an image representing an object J in front of the vehicle S, and a warning image W representing that the object J has been sensed. The second image G2a is an image of a selection screen on which the driver selects a type of vehicle state to be displayed on the display section 6, the second image G2b is an image representing the traveling state of the vehicle S, and the second image G2c is an image representing the state of the auxiliary device of the vehicle S. The second image G2b and the second image G2c are images to be displayed when selected by the driver in a state where the selection screen (second image G2a) is being displayed on the display section 6.

For example, the display control apparatus 10 causes the display section 6 to display the first image G1 upon sensing of the object J by the object sensing sensor 2. For example, the display control apparatus 10 changes the first image G1 being displayed by the display section 6 to the second image G2a or changes the second image G2a being displayed by the display section 6 to the second image G2b or the second image G2c upon operation of the operation section 1 by the driver.

Meanwhile, from the standpoint of safety, the display control apparatus 10 is required to prioritize displaying the first image G1 on the display section 6 over the second images G2. To cope with this, in a case where the object sensing sensor 2 has sensed the object J, the display control apparatus 10 can prioritize displaying the first image G1 on the display section 6 by displaying the first image G1 even if the driver performs operation to display the second image G2 on the display section 6. However, in this case, the display control apparatus 10 does not display the second image G2, but displays the first image G1 upon sensing of another vehicle in front of the vehicle S or a pedestrian crossing a sidewalk by the object sensing sensor 2 even if the vehicle S has temporarily stopped due to the occurrence of a traffic jam or a signal. Accordingly, opportunities when the driver can check the vehicle state of the vehicle S decrease, and it becomes difficult for the driver to check the vehicle state.

In view of this, in a case where the state of the transmission sensed by the position sensor 5 represents neutral “N,” the display control apparatus 10 changes the first image G1 being displayed by the display section 6 to a second image G2 corresponding to operation accepted by the operation section 1 under a condition that the vehicle S has been stopped. By an operation in this manner, even if the object sensing sensor 2 has sensed the object J in front of the vehicle S when the vehicle S has temporarily stopped, the display control apparatus 10 can display a second image G2 corresponding to operation of the operation section 1 by the driver provided that the driver performs operation to switch the position of the shift lever to the position of neutral “N”in advance.

Hereinbelow, the configuration and operation of the display control apparatus 10 are explained in detail.

### Configuration of Display Control Apparatus 10

As depicted in FIG. 1, the display control apparatus 10 has a storage section 11 and a control section 12. The control section 12 has an accepting section 121, a sensing section 122, an acquiring section 123, a display control section 124, and a notifying section 125.

For example, the storage section 11 has a storage medium such as a ROM (Read Only Memory), a RAM (Random Access Memory), an HDD (Hard Disk Drive), or an SSD (Solid State Drive). The storage section 11 has stored thereon programs to be executed by the control section 12, and various types of information for displaying the first image G1 and the second images G2 on the display section 6.

The control section 12 is a processor such as a CPU (Central Processing Unit) or an ECU (Electronic Control Unit). By executing programs stored on the storage section 11, the control section 12 functions as the accepting section 121, the sensing section 122, the acquiring section 123, the display control section 124, and the notifying section 125. The control section 12 may include one processor or may include a plurality of processors or a combination of one or more processors and an electronic circuit.

The accepting section 121 accepts operation of the display section 6 included in the vehicle S. For example, the accepting section 121 accepts operation to switch the display between the first image G1 and the second image G2a or operation to switch the display from a second image G2 being displayed in the plurality of second images G2 (second image G2a, second image G2b, and second image G2c) to another second image G2. The sensing section 122 senses the object J in front of the vehicle S. For example, the sensing section 122 senses the object J by acquiring a sensing signal representing that the object sensing sensor 2 has sensed the object J.

The acquiring section 123 acquires vehicle speed information representing the vehicle speed of the vehicle S. For example, the acquiring section 123 acquires vehicle speed information including the vehicle speed sensed by the vehicle speed sensor 3. The acquiring section 123 acquires pedal information representing the state of the brake pedal operated by the driver of the vehicle S. For example, the acquiring section 123 acquires pedal information representing whether or not the brake pedal of the vehicle S sensed by the pressing amount sensor 4 is in the pressed state. The acquiring section 123 acquires transmission information representing the state of the transmission operated by the driver. For example, the acquiring section 123 acquires transmission information including the state of the transmission determined by the position sensor 5.

The display control section 124 causes the display section 6 to display the first image G1 representing that the sensing section 122 has sensed an object in front of the vehicle S. The display control section 124 causes the display section 6 to display a second image G2 representing the traveling state of the vehicle S and/or the state of an auxiliary device included in the vehicle S. The display control section 124 may display another image different from the first image G1 and the second images G2 depending on the state of the vehicle S. Specifically, the display control section 124 may cause the display section 6 to display an image representing a song title corresponding to music in a case where audio equipment included in the vehicle S is outputting the music, or may cause the display section 6 to display an image prompting the driver to take a rest in a case where the driver has been driving the vehicle S for a predetermined time (e.g. two hours) or longer.

For example, the display control section 124 causes the display section 6 to display one image of the first image G1 and a second image G2, or changes the image being displayed by the display section 6 from one to another. For example, the display control section 124 causes the display section 6 to display the first image G1 upon sensing of the object J in front of the vehicle S by the sensing section 122. For example, upon acceptance of operation by the accepting section 121, the display control section 124 changes the first image G1 being displayed on the display section 6 to the second image G2a corresponding to the operation, or changes the second image G2a being displayed on the display section 6 to the second image G2b or second image G2c corresponding to the operation.

In a case where the state of the transmission included in the vehicle S is neutral “N,” the vehicle speed of the vehicle S is equal to or lower than a predetermined vehicle speed, and the brake pedal included in the vehicle S is the pressed state, the display control section 124 changes the first image G1 being displayed by the display section 6 to a second image G2 corresponding to predetermined operation in response to acceptance of the predetermined operation by the accepting section 121. For example, the predetermined operation is operation to check the vehicle state of the vehicle S.

For example, in a case where the state of the transmission included in the transmission information represents neutral “N,” the display control section 124 changes the first image G1 being displayed by the display section 6 and representing that the sensing section 122 has sensed an object to a second image G2 corresponding to predetermined operation accepted by the accepting section 121 provided that a predetermined condition is satisfied. The predetermined condition is that the vehicle speed included in the vehicle speed information is equal to or lower than the predetermined vehicle speed, and the state of the brake pedal included in the pedal information is the pressed state (i.e. the vehicle S has been stopped). For example, the predetermined vehicle speed is 0 km per hour.

By an operation in the manner described above, in a case where the state of the transmission is neutral “N” when the vehicle S is in the stopped state, the display control section 124 can change the first image G1 being displayed by the display section 6 to a second image G2. Thereby, in a case where the vehicle S is in a temporarily stopped state due to the occurrence of a traffic jam or a signal, and it is not necessary to cause the display section 6 to display the first image G1 representing the sensing of the object J, the display control section 124 can cause a second image G2 corresponding to predetermined operation accepted by the accepting section 121 to be displayed. As a result, even in a case where there is the object J in front of the vehicle S while the vehicle S has been stopped, the driver can check the vehicle state of the vehicle S by operating the shift lever such that the position of shift lever is shifted to the position of neutral “N,” and operating the operation section 1.

In a case where the state of the transmission included in the vehicle S is neutral “N,” the vehicle speed of the vehicle S is equal to or lower than the predetermined vehicle speed, and the brake pedal included in the vehicle S is in the pressed state, the display control section 124 may hide the first image G1 even if the accepting section 121 has not accepted predetermined operation. For example, in a case where the state of the transmission included in the transmission information is neutral “N,” and the predetermined condition is satisfied, the display control section 124 hides the first image G1 representing that the sensing section 122 has sensed the object J even if the accepting section 121 has not accepted predetermined operation. For example, in a case where the position of the shift lever is the position of neutral “N,” and the predetermined condition is satisfied, the display control section 124 hides the first image G1 even if the sensing section 122 has sensed the object J in a state where the accepting section 121 has not accepted predetermined operation.

By hiding the first image G1 in the manner described above, the display control section 124 can reduce unnecessary notification to the driver that the object J has been sensed when the vehicle S is in the stopped state, even if the first image G1 can be displayed.

In a case where a lane by which the vehicle S is stopped is inclined, if the brake pedal is in the un-pressed state, there is a possibility that the vehicle S moves even if the vehicle speed is 0 km per hour. In addition, even if the brake pedal is in the pressed state, the vehicle S is in the traveling state in a case where the vehicle speed is higher than 0 km per hour. In view of this, in a case where the state of the transmission included in the transmission information is neutral “N,” the display control section 124 may continue the display of the first image G1 by the display section 6 provided that the predetermined condition is not satisfied.

In a case where the vehicle speed of the vehicle S is higher than the predetermined vehicle speed, the display control section 124 may continue the display of the first image G1 even if the accepting section 121 has accepted predetermined operation while the display section 6 is displaying the first image G1. In a case where the brake pedal is not in the pressed state, the display control section 124 may continue the display of the first image G1 even if the accepting section 121 has accepted predetermined operation while the display section 6 is displaying the first image G1. By operating in this manner, the display control section 124 can prohibit the display of a second image G2 corresponding to predetermined operation by the driver in a case where there is a possibility that the vehicle S moves or the vehicle S is moving, even if the position of the shift lever is at the position of neutral “N.”

Even if the vehicle speed is 0 km per hour, and the brake pedal is in the pressed state, there is a possibility that the vehicle S moves for a reason that the pressing amount of the brake pedal is small, in a case where the position of the shift lever is the position of drive “D.” In view of this, in a case where the state of the transmission represents gears for forward movement, the display control section 124 may continue the display of the first image G1 even if the accepting section 121 has accepted predetermined operation while the display section 6 is displaying the first image G1. For example, in a case where the state of the transmission included in the transmission information represents gears for forward movement, the display control section 124 continues the display of the first image G1. The gears for forward movement mean the number of engaged forward gears or drive “D.” By operating in this manner, in a case where there is a possibility that the vehicle S moves, the display control section 124 can prohibit the display of a second image G2 corresponding to predetermined operation by the driver, and display the first image G1 representing that the object J has been sensed.

In a case where the state of the transmission is reverse “R” or parking “P,” the display control section 124 may change the first image G1 being displayed by the display section 6 to a second image G2 in response to acceptance of predetermined operation by the accepting section 121 while the first image G1 is being displayed on the display section 6. In a case where the state of the transmission included in the transmission information is reverse “R” or parking “P,” the display control section 124 may change the first image G1 being displayed by the display section 6 to a second image G2 upon acceptance of predetermined operation by the accepting section 121. By operating in this manner, in a case where the vehicle S has been parked and in a case where the vehicle S is backing up, the display control section 124 can display a second image G2 corresponding to predetermined operation by the driver.

By referring to a display table stored on the storage section 11, the display control section 124 may decide whether to or not to change the first image G1 being displayed by the display section 6 to a second image G2 corresponding to predetermined operation accepted by the accepting section 121. The display table is a table representing permission or prohibition of a change from the display of the first image G1 to the display of a second image G2 corresponding to the vehicle speed, the state of the brake pedal, and the state of the transmission.

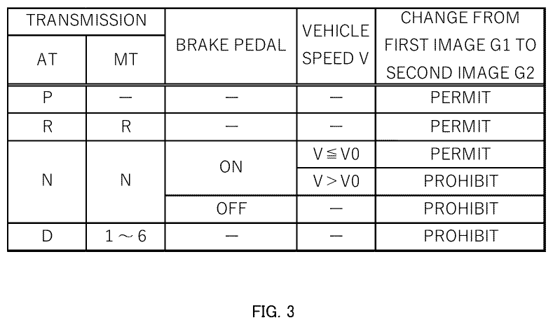

FIG. 3 is a drawing depicting an example of the display table. FIG. 3 depicts AT (Automatic Transmission) and MT (Manual Transmission) as types of the transmission, and depicts states of the AT transmission, “P,” “R,” “N,” and “D,” and states of the MT transmission, “R,” “N,” and “1 to 6.” “1 to 6” represent the numbers of engaged forward gears (so-called gear stages). “ON” as indicated for the brake pedal represents the pressed state of the brake pedal, and “OFF” as indicated for the brake pedal represents the un-pressed state of the brake pedal. “V” as indicated for a vehicle speed V represents the vehicle speed of the vehicle S, and “V0” represents the predetermined vehicle speed (e.g. 0 km per hour).

For example, by referring to the display table depicted in FIG. 3, the display control section 124 decides to change the first image G1 being displayed by the display section 6 to a second image G2 or to continue the display of the first image G1 on the basis of the vehicle speed, the state of the brake pedal, and the state of the transmission acquired by the acquiring section 123. In a case where the state of the transmission included in the transmission information acquired by the acquiring section 123 is neutral “N,” the display control section 124 may decide to change the first image G1 being displayed by the display section 6 to a second image G2 or continue the display of the first image G1 by referring to the display table.

Specifically, the display control section 124 identifies the vehicle speed “0 km per hour” included in the vehicle speed information, the state “ON” of the brake pedal included in the pedal information, and the state “N” of the transmission included in the transmission information that have been acquired by the acquiring section 123. By referring to the display table stored on the storage section 11, the display control section 124 identifies a change “permission” from the first image G1 to a second image G2 corresponding to the vehicle speed “0 km per hour,” the state “ON” of the brake pedal, and the state “N” of the transmission. Then, the display control section 124 decides to change the first image G1 being displayed by the display section 6 to a second image G2 on the basis of the identified “permission.” By operating in this manner, the display control section 124 can decide an image to be displayed on the display section 6 on the basis of the display table stored on the storage section 11, and accordingly can reduce processing load for the decision.

The notifying section 125 notifies the driver of the vehicle S that a predetermined state exists by causing the display section 6 to display a notification image or causing the sound output section 7 to output a notification sound. The predetermined state is a first state where the first image G1 being displayed by the display section 6 can be changed to a second image G2 corresponding to predetermined operation or a second state where the first image G1 representing that the sensing section 122 has sensed the object J is to be hidden even if the accepting section 121 has not accepted predetermined operation.

In a case where the state of the transmission included in the vehicle is neutral “N,” the vehicle speed V of the vehicle S is equal to or lower than the predetermined vehicle speed V0, and the brake pedal included in the vehicle S is in the pressed state, the notifying section 125 notifies the driver of the vehicle S that a state where the first image G1 can be changed to a second image G2 exists or a state where the first image G1 is to be hidden exists. For example, in a case where the state of the transmission included in the transmission information is neutral “N,” and the predetermined condition is satisfied, the notifying section 125 notifies the driver of the vehicle S that the predetermined state exists upon acceptance of operation by the accepting section 121.

By operating in this manner, the notifying section 125 can make it easier for the driver to know that the driver can operate the operation section 1 to cause a second image G2 to be displayed. Note that a notification image for notifying the first state and a notification image for notifying the second state may be the same or may be different. A notification sound for notifying the first state and a notification sound for notifying the second state may be the same or may be different.

### Process Sequence at Display Control Apparatus 10

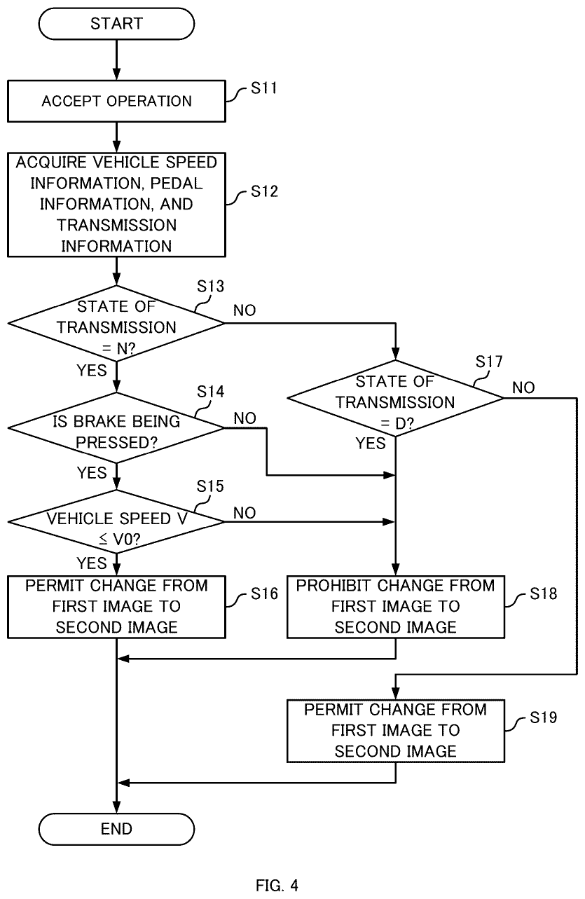

FIG. 4 is a drawing depicting an example of a process sequence at the display control apparatus 10. The process sequence depicted in FIG. 4 is a process sequence representing an operation to decide whether to or not to change the first image G1 being displayed by the display section 6 to a second image G2 corresponding to operation accepted by the accepting section 121. Note that the vehicle speed V0 depicted in FIG. 4 is 0 km per hour.

The accepting section 121 accepts predetermined operation for displaying the second image G2 from the operation section 1 (S11). The acquiring section 123 acquires the vehicle speed information from the vehicle speed sensor 3, acquires the pedal information from the pressing amount sensor 4, and acquires the transmission information from the position sensor 5 (S12). In a case where the state of the transmission included in the transmission information is neutral “N” (YES at S13), the display control section 124 identifies the state of the brake pedal included in the pedal information and the vehicle speed V included in the speed information.

In a case where the brake pedal is in the pressed state (being pressed depicted in FIG. 4) (YES at S14), and the vehicle speed V is equal to or lower than the vehicle speed V0 (0 km per hour) (YES at S15), the display control section 124 permits a change from the first image G1 being displayed by the display section 6 to a second image G2 corresponding to the predetermined operation accepted by the accepting section 121 (S16). In a case where the brake pedal is not in the pressed state (NO at S14) or in a case where the vehicle speed V is higher than the vehicle speed V0 (NO at S15), the display control section 124 prohibits a change from the first image G1 being displayed by the display section 6 to the second image G2 corresponding to the predetermined operation accepted by the accepting section 121 (S18).

In a case where the state of the transmission included in the transmission information is not neutral “N” (NO at S13), the display control section 124 identifies whether or not the state of the transmission is drive “D.” In a case where the state of the transmission is drive “D” (YES at S17), the display control section 124 prohibits a change from the first image G1 being displayed by the display section 6 to the second image G2 corresponding to the predetermined operation accepted by the accepting section 121 (S18). In a case where the state of the transmission is not drive “D” (NO at S17), the display control section 124 permits a change from the first image G1 being displayed by the display section 6 to the second image G2 corresponding to the predetermined operation accepted by the accepting section 121 (S19).

Note that the display control apparatus 10 may execute the process at Step S11 after executing the processes from Step S12 to Step S19. That is, at the display control apparatus 10, the accepting section 121 may accept predetermined operation after the display control section 124 decides whether to or not to permit a change from the first image G1 to a second image G2. That is, the accepting section 121 accepts predetermined operation (operation of the display section 6) after the display control section 124 has decided whether to or not to permit to change the first image G1 being displayed by the display section 6 to a second image G2. In this case, the display control apparatus 10 repeats the processes from Step S12 to Step S19 at predetermined intervals. For example, the predetermined intervals are intervals shorter than the length of time from a time at which the driver has executed operation of the operation section 1 until a time at which the driver executes the next operation, and are stored on the storage section 11.

By operating in this manner, even if the driver operates the operation section 1 immediately after a change from the first image G1 to a second image G2 is permitted, and the shift lever has been operated such that the position of the shift lever is shifted to the position of drive “D,” the display control apparatus 10 can prohibit a change to a second image G2 corresponding to the next predetermined operation.

### Effects of Display Control Apparatus 10

As explained above, the display control apparatus 10 has: the accepting section 121 that accepts operation of the display section 6 included in the vehicle S; the sensing section 122 that senses the object J in front of the vehicle S; the acquiring section 123 that acquires: the vehicle speed information representing the vehicle speed V of the vehicle S; the pedal information representing the state of the brake pedal operated by the driver of the vehicle S; and the transmission information representing the state of the transmission operated by the driver; and the display control section 124 that causes the display section 6 to display the first image G1 upon sensing of the object J by the sensing section 122. Then, in a case where the state of the transmission is neutral, the vehicle speed V is equal to or lower than the predetermined vehicle speed V0, and the brake pedal is in the pressed state, the display control section 124 changes the first image G1 being displayed by the display section 6 to a second image G2 corresponding to predetermined operation in response to acceptance of the predetermined operation by the accepting section 121.

By being configured in this manner, in a case where the state of the transmission is neutral “N” when the vehicle S is in the stopped state, the display control apparatus 10 can change the first image G1 being displayed by the display section 6 to a second image G2 corresponding to the predetermined operation accepted by the accepting section 121. As a result, in a case where the vehicle S has been stopped due to the occurrence of a traffic jam or a signal, the driver can cause the second image G2 according to the operation of the operation section 1 to be displayed by operating the shift lever such that the position of the shift lever is shifted to the position of neutral “N.” Then, in a case where it is not necessary to cause the display section 6 to display the first image G1 representing that the object J in front of the vehicle S has been sensed, and it is highly safe, the display control apparatus 10 can accept operation by the driver, and cause a second image G2 corresponding to the operation to be displayed.

Whereas the present invention has been explained using embodiments thus far, the technical scope of the present invention is not limited by the scope described in the embodiments described above, but various modifications and changes are possible within the scope of a gist of the present invention. For example, all or some of apparatuses can be configured functionally or physically distributed or integrated in any units. In addition, new embodiments that are generated by any combination of a plurality of embodiments are also included in embodiments of the present invention. Effects of the new embodiments generated by the combination combine effects of the original embodiments.

1. A display control apparatus comprising:
an accepting section that accepts operation of a display section included in a vehicle;
a sensing section that senses an object in front of the vehicle;
an acquiring section that acquires: vehicle speed information representing a vehicle speed of the vehicle; pedal information representing a state of a brake pedal operated by a driver of the vehicle; and transmission information representing a state of a transmission operated by the driver; and
a display control section that causes the display section to display a first image upon sensing of the object by the sensing section, wherein
in a case where the state of the transmission is neutral, the vehicle speed is equal to or lower than a predetermined vehicle speed, and the brake pedal is in a pressed state, the display control section changes the first image being displayed by the display section to a second image corresponding to predetermined operation in response to acceptance of the predetermined operation by the accepting section.

2. The display control apparatus according to claim 1, wherein, in a case where the state of the transmission represents a gear for forward movement, the display control section continues a display of the first image even if the accepting section has accepted the predetermined operation while the display section is displaying the first image.

3. The display control apparatus according to claim 1, wherein, in a case where the state of the transmission is reverse or parking, the display control section changes the first image being displayed by the display section to the second image in response to acceptance of the predetermined operation by the accepting section while the display section is displaying the first image.

4. The display control apparatus according to claim 1, wherein, in a case where the vehicle speed is higher than a predetermined vehicle speed, the display control section continues a display of the first image even if the accepting section has accepted the predetermined operation while the display section is displaying the first image.

5. The display control apparatus according to claim 1, wherein, in a case where the brake pedal is not in a pressed state, the display control section continues a display of the first image even if the accepting section has accepted the predetermined operation while the display section is displaying the first image.

6. The display control apparatus according to claim 1, further comprising:
a storage section that stores a display table representing permission or prohibition of a change from a display of the first image to a display of the second image corresponding to the vehicle speed, the state of the brake pedal, and the state of the transmission, wherein
in a case where the state of the transmission included in the transmission information represents neutral, by referring to the display table, the display control section decides to change the first image being displayed by the display section to the second image or to continue a display of the first image on a basis of the vehicle speed, the state of the brake pedal, and the state of the transmission acquired by the acquiring section.

7. The display control apparatus according to claim 1, wherein, in a case where the state of the transmission is neutral, the vehicle speed is equal to or lower than a predetermined vehicle speed, and the brake pedal is in a pressed state, the display control section hides the first image even if the accepting section has not accepted the predetermined operation.

8. The display control apparatus according to claim 1, further comprising a notifying section that notifies the driver of the vehicle that a state where the first image can be changed to the second image exists or a state where the first image can be hidden exists in a case where the state of the transmission is neutral, the vehicle speed is equal to or lower than a predetermined vehicle speed, and the brake pedal is in a pressed state.

9. The display control apparatus according to claim 1, wherein the display control section causes the display section to display the first image representing that the object in front of the vehicle has been sensed.

10. The display control apparatus according to claim 1, wherein the display control section causes the display section to display the second image representing a traveling state of the vehicle and/or a state of an auxiliary device included in the vehicle.

11. The display control apparatus according to claim 1, wherein the accepting section accepts operation of the display section after the display control section decides whether to or not to permit to change the first image being displayed by the display section to the second image.

12. A display control method executed by a computer, the display control method comprising:
an acceptance step of accepting operation of a display section included in a vehicle;
a sensing step of sensing an object in front of the vehicle;
an acquisition step of acquiring: vehicle speed information representing a vehicle speed of the vehicle; pedal information representing a state of a brake pedal operated by a driver of the vehicle; and transmission information representing a state of a transmission operated by the driver; and
a display control step of causing the display section to display a first image upon sensing of the object at the sensing step, wherein
at the display control step, in a case where the state of the transmission is neutral, the vehicle speed is equal to or lower than a predetermined vehicle speed, and the state of the brake pedal is in a pressed state, the first image being displayed by the display section is changed to a second image corresponding to predetermined operation in response to acceptance of the predetermined operation at the acceptance step.
